(19) United States
(12) Patent Application Publication
(10) Pub. No.: US 2010/0288615 A1
(43) Pub. Date: Nov. 18, 2010

(54) KEYBOARD DEVICE

(75) Inventors: Takahito MAFUNE, Fukushima-ken (JP); Naoki YAMADA, Fukushima-ken (JP); Masahiro ISHIDA, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/776,760

(22) Filed: May 10, 2010

(30) Foreign Application Priority Data
May 18, 2009 (JP) 2009-119939

(51) Int. Cl. H01H 13/76

(52) U.S. Cl. 200/5 A; 200/310

(57) ABSTRACT

A keyboard device includes: a plurality of arranged key tops; a support mechanism which supports each of the key tops so as to be elevatable; a membrane switch which outputs a switch signal when the key top moves down with an operation of the support mechanism performed upon pressing the key top; and an illumination mechanism which includes a light source and a light guiding member, and propagates light of the light source to the inside of the light guiding member so as to illuminate the key top, wherein the light guiding member is provided with a plurality of groove portions provided in the course of a path of the light and changing a light advancing direction, and wherein the light reaches the key top by the groove portions.

### CROSS REFERENCE TO RELATED APPLICATION

The present invention contains subject matter related to and claims the benefit of Japanese Patent Application JP 2009-119939 filed in the Japanese Patent Office on May 18, 2009, the entire contents of which is incorporated herein by reference.

### BACKGROUND OF THE DISCLOSURE

1. Technical Field

The present invention relates to a keyboard device in which contact points come into contact with each other upon pressing a key top, and particularly, to a keyboard device having a function of allowing light to illuminate a key top from the rear surface thereof.

2. Related Art

In recent years, a keyboard device has been used which has a function of allowing light to illuminate individual key tops from the rear surfaces thereof so that the key tops are visible even in a dark place.

FIG. 8 shows an example of a keyboard device having an illumination mechanism with a configuration of a related art.

A keyboard device 101 has a configuration in which a rubber dome 112 is bent upon pressing a key top 104, and a contact input portion 124 of an interconnection substrate provided on a membrane sheet body 120 laminated on a metal plate 102 as a base substrate enters an electrical conduction state so as to generate an input signal. As an illumination mechanism 130 for illuminating the key top 104, one of light guiding sheet 134 having a plurality of LEDs 131 arranged on the side surface thereof is disposed on the rear surface of the metal plate 102.

That is, the illumination mechanism 130 of the keyboard device 101 of the related art includes a reflection sheet 135 disposed on the lowermost layer, the light guiding sheet 134 disposed thereon, and a plurality of LEDs (Light Emitting Diodes) 131 arranged on the side surface of the light guiding sheet 134. The plurality of LEDs 131 is mounted to a flexible interconnection substrate (FPC) 138 to which power and signals are supplied, and is aligned so as to emit light from the side surface of the light guiding sheet 134 toward the inside of the light guiding sheet 134. In the light guiding sheet 134, the side surface where the LEDs 131 are arranged is used as a light incident surface, and the upper surface thereof is used as a light emitting surface. Light incident into the light incident surface and propagated therein is guided in the inside of the light guiding sheet 134 by a light diffusion portion 134a provided on the bottom surface thereof so as to be emitted from the light emitting surface.

In addition, a light shielding sheet 133, a metal plate 102 as a reinforcing plate, and a membrane sheet body 120 are sequentially laminated from the downside on the upper surface of the illumination mechanism 130. Further, the membrane sheet body 120 has a generally known configuration in which two sheets are overlapped with each other so that an upper contact point (not shown) provided on a pressure sheet (not shown) and a lower contact point (not shown) provided on a substrate sheet (not shown) are spaced from each other and are opposed to each other. The light shielding sheet 133, the metal plate 102, and the membrane sheet body 120 are provided with light transmitting portions (openings are provided for the light shielding sheet 133 and the metal plate 102, and a non-interconnection portion formed by a transparent sheet is provided for the membrane sheet body 120, where a portion for allowing light to be transmitted therethrough is referred to as a “light transmitting portion”) so as to transmit light emitted from the illumination mechanism 130 disposed on the lower layer.

In addition, a rubber dome 112 formed by an elastic member and having an upside down bowl shape is disposed on the upper surface of the membrane sheet body 120 so as to give an urging force to the key top 104 in a direction moving away from the metal plate 102. A cavity is provided in the inside of the rubber dome 112, and a pressure convex portion (not shown) is provided in the cavity so as to protrude downward. Then, the rubber dome 112 is bent upon pressing the key top 104, and the pressure convex portion presses the pressure sheet of the membrane sheet body 120 so that the upper contact point thereof comes into contact with the lower contact point of the substrate sheet so as to enter an electrical conduction state.

Further, a housing rubber 109 formed by a transparent elastic material is disposed below the key top 104 so as to surround the rubber dome 112, where the housing rubber serves as a support member which supports and urges the key top 104 upward in a normal state, and is bent upon pressing the key top 104, so that the key top 104 is elevatable in the up/down direction.

In the key top 104 supported by the rubber dome 112 and the housing lever 109, the upper surface thereof is provided with a blank-letter-shaped display portion 104a which has an image of a desired character formed by an opening.

Then, when the light of the LED 131 passes through the light guiding sheet 134 and passes through the light transmitting portion and the housing lever 109, each key top 104 is illuminated from the rear surface thereof, and the display portion 104a is brightly visible by the illumination light from the rear surface thereof.

In addition, in a keyboard device disclosed in Japanese Utility Model Registration No. 3082585, light emitted from a plate-shaped light emitting element is given to a key top through an opening (light transmitting portion) provided on a circuit board and an elastic sheet. In a keyboard device disclosed in Japanese Unexamined Patent Application Publication No. 2002-251937, an EL (electro-luminance) element is provided on the lower side of a base substrate so as to give light to each key top through a perforation hole (light transmitting portion) opened from a base substrate.

As in the keyboard devices of the related art, in the keyboard device having a configuration an which the light of the light source passes through the light transmitting portion located thereabove so as to illuminate the rear surface of each key top, the light used to illuminate the key top is interrupted by other members interposed between the key top and the light source, and the utilization efficiency of the light of the light source is extremely poor (loss of light).

In addition, in the case of using the light guiding sheet the illumination mechanism, it is difficult to uniformly illuminate each key top. That is, there is a tendency that an area in the vicinity of the light source is bright due to a large amount of propagated light, but an area away from the light source is dark due to a small amount of propagated light reaching the far area. For example, the brightness of the display portion of one key top may be different in accordance with the formation position and size of the light transmitting portion and the size of the display portion provided in the key top (a variation in brightness). In addition, there are problems in that light is not intensively given to the display portion as an illumination target of each key top, and the display portion is not sufficiently illuminated (insufficient brightness).

In addition, when light is allowed to illuminate the entire surface (entire area) of the light guiding sheet, the number of light sources increases, which causes an increase in the manufacture cost.

Further, in the configuration of the related art, the number of components laminated below the key top is large, which is not desirable for the demand such as a decrease in thickness of the keyboard device and a decrease in the manufacture cost thereof.

These and other drawbacks exist.

### SUMMARY OF THE DISCLOSURE

An advantage of some aspects of the invention is to provide a keyboard device capable of clearly illuminating an illumination target position of each key top by highly efficiently giving, light of a light source to the key top, and of realizing a decrease in thickness of the keyboard device.

According to various embodiments of the disclosure, there is provided a keyboard device including: a plurality of arranged key tops; a support mechanism which supports each of the key tops so as to be elevatable; a membrane switch which outputs a switch signal when the key top moves down with an operation of the support mechanism performed upon pressing the key top; and an illumination mechanism which includes a light source and a light guiding member, and propagates light of the light source to the inside of the light guiding member so as to illuminate the key top. In these embodiments, the light guiding member is provided with a plurality of groove portions provided in the course of a path of the light and changing a light advancing direction, and the light reaches the key top by the groove portions.

According to an exemplary keyboard device, since the groove portion is provided in the light guiding member so as to change alight advancing direction of the light of the light source, it is possible to propagate the light while avoiding obstacles such as a plurality of holes provided in the middle of the light guiding member, and to disperse the light so as to illuminate the key top.

In addition, each of the groove portions of the light guiding member is formed by cutting in the course of the path of the propagated light in a direction from the rear surface of the light chiding member to the inside thereof. At least one of the cutting angle, the cutting length, the cutting depth, and the cutting width of the groove portion is changed in response to a distance from the light source.

Since it is possible to control the light amount of the light of the light source by controlling the cutting angle, the cutting length, the cutting depth, and the cutting width the groove portion, it is possible to uniformly maintain the brightness of the key top.

According to various embodiments, there is provided a keyboard device including: a base substrate; a plurality of arranged key tops; a support mechanism which is provided on the base substrate and supports each of the key tops so as to be elevatable; a membrane switch which is disposed between the base substrate and the key top and includes a contact input portion including lower and upper contact points disposed while facing each other in the up/down direction with a gap interposed therebetween when the key top is not pressed, and outputs a signal by allowing the corresponding lower and upper contact points of the contact input portion to come into contact with each other when the key top is pressed; and an illumination mechanism which includes a light source and a light guiding member disposed at the same position as that of the membrane switch or a position closer to the key top than the membrane switch and propagating light of the light source thereinto and guiding the light to each key top. In these embodiments, the light guiding member includes: a light guiding member body which is provided with a light propagating portion which extends in the length and width directions within the surface of the light guiding member body so as to open switch openings at positions corresponding to the arrangement positions of the key tops and to propagate the light to the inside of the light guiding member body, and reflection illumination portions, each of which extends from the light propagating portion to the inside of each of the switch openings so as to be interposed in a space between the key top and the membrane switch; a light shielding member which is disposed on the upper surface of the light guiding member body so as to interrupt light leaking upward from the light propagating portion; and a reflection member which is disposed on the lower surface of the light propagating portion and the reflection illumination portions so as to reflect the light, leaking downward from the light guiding member body, toward each key top.

According to the exemplary keyboard devices of the disclosure, the reflection illumination portion extending from the light propagating portion of the light guiding member body is disposed below the key top. For this reason, its possible to give the light to the key top without much interruption of the light emitted from the surface of the reflection illumination portion of the light guiding member body, and thus to efficiently illuminate the key top. In addition, since the light guiding member body is provided at the same position as that of the membrane switch and a position thereabove, it is not necessary to make the sheet or the contact point located below the light guiding member body transparent. Accordingly, since it is not necessary to make the portion lower than the light guiding member body transparent, it is possible to reduce the material cost of the keyboard device.

According to various embodiments of the disclosure, there is provided a keyboard device including: a base substrate; a plurality of arranged key tops; a support mechanism which is provided on the base substrate and supports each of the key tops so as to be elevatable; a membrane switch which is disposed between the base substrate and the key top and includes a contact input portion including lower and upper contact points disposed while facing each other in the up/down direction with a gap interposed therebetween when the key top is not pressed, and outputs a signal by allowing the corresponding lower and upper contact points of the contact input portion to come into contact with each other when the key top is pressed; and an illumination mechanism which includes a light source and a light guiding member disposed at the same position as that of the membrane switch or a position closer to the key top than the membrane switch and guiding the light of the light source to each key top while propagating the light therein. In these embodiments, the light guiding member includes: a first area provided with only one sheet of a light guiding member body including a light propagating portion which extends in the length and width directions so as to open switch openings at positions corresponding to the arrangement positions of the key tops and to propagate the light to the inside of the light guiding member body, and reflection illumination portions, each of which extends from the light propagating portion to the inside of each of the switch openings so as to be interposed in a space between the key top and the membrane switch; and a second area formed as a double-layered structure in which another light guiding member body is laminated on the upper surface of the light guiding member body posed in the first area. Also, the light guiding member includes: a first light guiding member body including a first area portion provided with a light propagating portion which extends in the length and width directions within the surface of the first light guiding member body so as to open switch openings at positions corresponding to the arrangement positions of the key tops in the first area and to propagate the light to the inside of the first light guiding member body, and reflection illumination portions, each of which extends from the light propagating portion to the inside of each of the switch openings so as to be interposed in a space between the key top and the membrane switch; and a second area portion continuously and integrally formed with the first area portion and provided with a light propagating portion which extends in the length and width directions within the surface of the first light guiding member body so as to open switch openings at positions corresponding to the arrangement positions of the key tops in the second area and to propagate the light to the inside of the first light guiding member body, a second light guiding member body disposed only in the second area and provided with a light propagating portion which is disposed on the upper surface of the first light guiding member body of the second area and extends in the length and width directions within the surface of the second light guiding member body so as to open switch openings at positions corresponding to the arrangement positions of the key tops in the second area portion and to propagate the light to the inside of the second light guiding member body, and reflection illumination portions, of which extends from the light propagating portion to the inside of each of the switch openings so as to be interposed in a space between the key top and the membrane switch; a light shielding member which is disposed on the upper surface of the first light guiding member body in the first area and the upper surface of the light propagating portion of the second light guiding member body in the second area so as to interrupt light advancing toward the key top; and a reflection member which is disposed on the lower surface of the reflection illumination portion and the light propagating portion of the first light guiding member body so as to reflect light, advancing in a direction opposite to the key top, toward each key top. At least a part of the light source is disposed on the side of the light guiding member body disposed in the second area.

According to various embodiments, the reflection illumination portion extending from the light propagating portion of the light guiding member body is disposed below the key top. For this reason, it is possible to give the light to the key top without much interruption of the light emitted from the surface of the reflection illumination portion of the light guiding member body, and thus to efficiently illuminate the key top. In addition, since the light guiding member body is provided at the same position as that of the membrane switch and a position thereabove, it is not necessary to make the sheet or the contact point located below the light guiding member body transparent. Accordingly, it is possible to reduce the material cost of the keyboard device. Further, in the first area of the light guiding member, the key top is illuminated by using the light propagated to the second area portion of the first light guiding member body disposed in the second area. At this time, since the light propagated to the second area portion of the first light guiding member body is not used as illumination light in the second area, it is possible to suppress the light from being attenuated in the inside of the first area portion. Accordingly, even when the first area is disposed at a position away from the light source, it is possible to illuminate the key top away from the light source at sufficient brightness.

In addition, the light propagating portion is provided with light control means for adjusting and controlling a light amount and a light path of the light propagated to the inside of the light guiding member body so as to uniformly disperse the light to the reflection illumination portion. In detail, the light control means may be as a groove portion which is provided in the course of the path of the propagated light in the light propagating portion in a direction from the rear surface of the light guiding member body to the inside thereof so as so allow straight advancing light of the light source to illuminate a surface portion provided inside the light propagating portion and to reflect and bend a desired light amount of the light to a desired direction.

Since the light path and the light amount of the light propagated to the inside of the light guiding member body is adjusted and controlled by the light control means, it is possible to uniformly disperse the light to the reflection illumination portion in the inside of the light guiding member body, and thus to concentrate the light on the reflection illumination portion.

In addition, the lower surface of the light guiding member disposed in the reflection illumination portion is formed as a rough surface.

Likewise, since the reflection member is formed as a rough surface, it is possible to diffuse the emitted light by using the rough surface as a light diffusion surface, and thus to more brightly illuminate the keyboard.

Further, the key top is provided with a display portion in which an image of a desired character is formed by transmission of illumination light, and the reflection illumination portion is provided at a position corresponding to the display portion.

Since the light emitted from the light guiding member body escapes from the rear surface of the key top through the opening of the display portion, the light is visible. Accordingly, it is possible for a user to recognize the character attached to the key top by using the light emitted from the rear surface of the key top.

Further, a light shielding layer as the light shielding member is printed and provided on the upper surface of the light propagating portion of the light guiding member body, and a reflection layer as the reflection member is printed and provided on the lower surface thereof.

Since the light shielding layer and the reflection layer are printed and provided on the light guiding member body, it is possible to decrease the thickness of the light guiding member, and thus to contribute a decrease in thickness of the keyboard device.

Furthermore, the light source is directly mounted to an upper surface of a sheet body of an uppermost layer constituting the membrane switch.

Since the light source is disposed on the sheet body of the uppermost layer constituting the membrane switch, and the illumination power is supplied from the sheet, it is possible omit the interconnection substrate supplying the illumination power of the light source, and thus to reduce the material cost of the keyboard device.

In addition, arrangement holes are provided from the rear surface of the light guiding member to the inside of the light propagating portion so as to fit and dispose light emitting portions of the light source thereinto, and at least a part of the light source is directly mounted to the inside of an area facing each of the arrangement holes the upper surface of the sheet body of the uppermost layer constituting the membrane switch.

Since the light source is disposed on the sheet body of the uppermost layer constituting the membrane switch, and the illumination power is supplied from the sheet, it is possible to omit the interconnection substrate supplying the illumination power of the light source, and thus to reduce the material cost of the keyboard device. Also, since the light source is disposed at a desired position of the light propagating portion within the surface, it is possible to shorten a distance from the light source to each key top. Accordingly, it is possible to improve the utilization efficiency of the light, and to more brightly and uniformly illuminate the key top.

Further, a support member is disposed below the key top so as to support the key top, and the support member is provided with a pressure convex portion facing downward. The membrane switch includes a contact input portion which includes a lower contact point provided on an upper surface of a substrate sheet and an upper contact point provided at a position facing the lower contact point of the pressure convex portion, and the lower contact point and the upper contact point are adapted to come into contact with each other when the key top is pressed and a pressure sheet of the contact input portion is pressed.

In the membrane switch with such a configuration, since one sheet of a sheet body is used, it is possible to realize a decrease in thickness of the keyboard device, and thus to reduce the material cost thereof.

Likewise, according to various embodiments of the disclosure, it is possible to improve the utilization efficiency of the light used to illuminate the key tops of the keyboard device. In addition, it is possible to concentrate the light on an illumination target position of each of the key tops. Further, is possible to reduce a variation in brightness of the illuminated key tops regardless of a variation in distance from the light sources. Furthermore, since the number of laminated sheets is decreased, there are excellent advantages in that it is possible realize a decrease in thickness of the keyboard device, and to reduce the material cost thereof.

### BRIEF DESCRIPTION OF THE DRAWINGS

FIG. 1 is a partially cross-sectional view showing a part of a keyboard device of an embodiment of the disclosure.

FIG. 2 is an enlarged explanatory diagram showing a structure of a light guiding member of an illumination mechanism of the keyboard device shown in FIG. 1.

FIG. 3 is a partial plan view showing a positional relationship between a light source and a groove portion provided in the light guiding member of the illumination mechanism of the keyboard device shown in FIG. 1.

FIG. 4 is an enlarged explanatory diagram showing a structure of another light guiding member of the illumination mechanism of the keyboard device shown in FIG. 1.

FIG. 5 is a partially cross-sectional view showing a part of the keyboard device having a structure of a membrane switch of the keyboard device of an embodiment of the disclosure.

FIG. 6 is a partial plan view showing a positional relationship between the light source and the groove portion provided in the light guiding member of the keyboard device of another embodiment of the invention.

FIG. 7 is an enlarged explanatory diagram showing a structure of the light guiding member of the illumination mechanism of the keyboard device of an embodiment of the disclosure.

FIG. 8 is a partially cross-sectional view showing a part of the keyboard device of an embodiment of a related art.

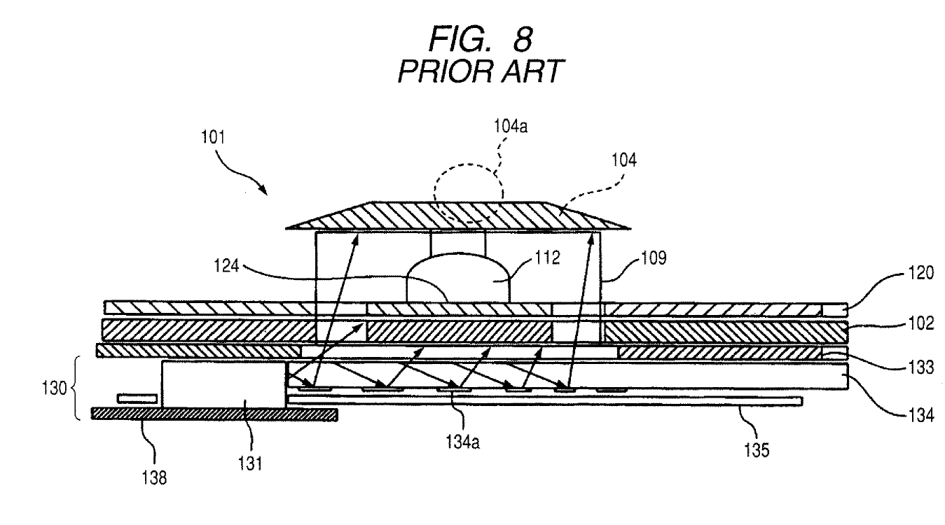

### DESCRIPTION OF EXEMPLARY EMBODIMENTS

The following description is intended to convey a thorough understanding of the embodiments described by providing a number of specific embodiments and details involving keyboard devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

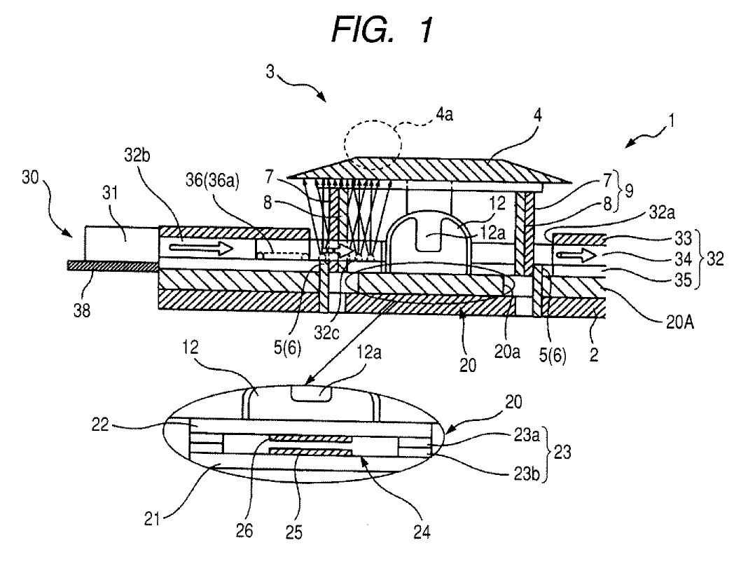

A keyboard device 1 of various embodiments of the disclosure shown in FIGS. 1 to 7 may be mounted to a book type, a laptop type, a desktop type personal computer, or the like.

FIG. 1 is a cross-sectional view showing a part of a key input unit 3 among a plurality of key input units 3 arranged in the length direction and the width direction on a upper surface of a metal plate 2 which may be a base substrate accommodated in a casing (not shown) of the keyboard device 1. As described below, the dimension of the key input unit 3 in the width direction may be different in accordance with zh size of each key top 4 disposed thereon, but the other structures are substantially the same.

As shown in FIG. 1, a membrane sheet body 20 constituting a membrane switch and an illumination mechanism 30 may be sequentially overlapped and fixed onto the metal plate 2, and a key top 4 may be provided at a position away from the upper of the metal plate 2.

In a portion provided with each key input unit 3 of the metal plate 2, a first support piece 5 and a second support piece 6 may be bent upward so as to protrude to the upper side of the membrane sheet body 20 through a perforation hole 20a provided in the membrane sheet body 20 and a switch opening 32a provided in the illumination mechanism 30.

A first movable support member 7 and a second movable support member 8 may be provided between each key top 4 and the metal plate 2. In the first movable support member 7, one end thereof may be supported to the first support piece 5 so as to be rotatable, and the other end thereof may be supported to the lower portion of the key top 4 so as to be rotatable and slidable in the width direction. In the second movable support member 8, one end thereof may be supported to the lower portion of the key top 4 so as to be rotatable, and the other end thereof may be supported to the second support piece 5 so as to be rotatable and slidable in the width direction. The center portions of the first and second movable support members 7 and 8 may be connected to each other so as to be rotatable in the longitudinal direction thereof. The first movable support member 7 and the second movable support member 8 constitute an X-shaped support link 9 which may be a support member for supporting the key top 4 so as to be elevatable in the up/down direction.

In addition, as shown in FIG. 1, the membrane support body 20 may include a substrate sheet 21, a pressure sheet 22, and a spacer layer 23 interposed between both sheets 21 and 22. In addition, a portion facing a pressure convex portion 12a of a rubber dome 12 may be provided with a contact input portion 24 instead of the spacer layer 23. The contact input portion 24 may be provided at a position facing the pressure convex portion 12a of the rubber dome 12 provided in each key input unit 3. In the contact input portion 24, a lower side contact point 25 may be provided on the upper surface of the substrate sheet 21, and an upper contact point 26 may be provided on the lower surface of the pressure sheet 22 so as to face the lower side contact point 25. The upper contact point 26 may be individually connected to a conductive pattern (not shown) wired to the pressure sheet 22, and the lower contact point 25 may be individually connected to a conductive pattern not shown) wired to the substrate sheet 21. In addition, the pressure sheet 22 may be thin and flexible, and polycarbonate, urethane, silicon, PET, etc. may be used.

In addition, the spacer layer 23 interposed between the substrate sheet 21 and the pressure sheet 22 in an area except for the contact input portion 24 may be an adhesive layer. The spacer layer 23 may include an organic resin layer 23a which may be provided on the upper surface of the substrate sheet 21 by the use of a resist material, etc, and an adhesive layer 23b which may be laminated thereon. The organic resin layer 23a may be provided on tree upper surface of the substrate sheet 21 in an area except for the contact point input portion 24 by a screen printing process, etc. The adhesive layer 23b may be provided on the upper surface of the organic resin layer 23a in an area except for the contact point input portion 24 by a screen printing process, etc., and the pressure sheet 22 may be fixed to the adhesive layer. Likewise, since the spacer layer 23 may be formed as the adhesive layer, the membrane sheet body 20 may be thin. In addition, since the spacer layer 23 may be formed as the laminated structure including the organic resin layer 23a and the adhesive layer 23b, a gap between the substrate sheet 21 and the pressure sheet 22 in the up/down direction may be maintained to be wide, and a facing gap between the lower contact point 25 and the upper contact point 26 in the up/down direction for each contact point input portion 24 may be maintained.

The rubber dome 12 disposed between the pressure sheet 22 and the key top 4 may be formed by an elastic member so as to have an upside down bowl shape. The rubber dome 12 may be an urging member which applies an urging force to the key top in the upward direction, which may be a direction moving away from the metal plate 2, and may serve as a support member for supporting the key top 4 together with the X-shaped support link 9 including the first movable support member 7 and the second movable support member 8. The inside of the lower side of the rubber dome 12 may be a cavity, and the pressure convex portion 12a may be integrated with the inside of the cavity so as to face downward. The upper surface of the key top 4 may be provided with a blank-letter-shaped display portion, 4a which may have an image of a desired character formed by an opening.

In addition, when the key top 4 is pressed, one end of the first movable support member 7 may rotate about the engagement portion of the first support piece 5 as a support point, and one end of the second movable support member 8 may rotate below the key top 4 so as to move down the key top 4. At this time, the rubber dome 12 may be pressed and crushed by the key top 4, and the pressure convex portion 12a may press the pressure sheet 22 of the contact point input portion 24, so that the upper contact point 26 comes into contact with the opposite lower contact point 25 so as to be electrically connected to each other. Accordingly, the key input signal may be obtained.

The illumination mechanism 30 may include alight source 31 and a light guiding member 32 which may be disposed between the key top 4 and the contact point input portion 24 of the membrane sheet body 20 so that light emitted from the light source 31 may be propagated therein and guided to each key top 4.

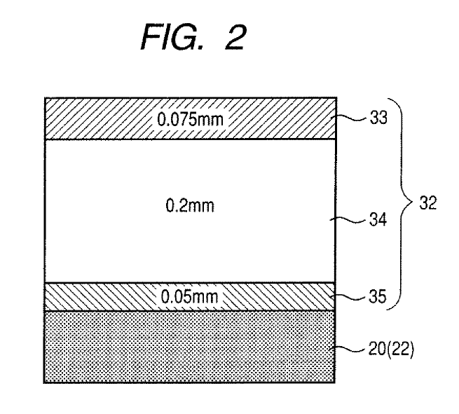

As shown in FIG. 2, the light guiding member 32 may include a light guiding sheet 34 (having a thickness of 0.2 mm) as a light guiding member body which propagates and guides light emitted from the light source 31 to each key top 4. The light guiding sheet 34 may have a wide area enough to extend throughout the entire keyboard device 1, and the surface thereof may be provided with substantially square-shaped switch openings 32a which may be opened so as to respectively correspond to the arrangement positions of the key tops 4, a light propagating portion 32b which may extend within the surface so as to have a matrix shape in the length direction and the width direction and to propagate light thereinto, and tongue-piece-shaped reflection illumination portions 32c, each of which may extend from the light propagating portion 32b to the inside of each of the switch openings 32a so as to be interposed in a space between the key top 4 and the membrane sheet body 20. The lower surface of the reflection illumination portion 32c may be formed as a rough surface by laser irradiation or a liquid agent treatment, and may serve as a light diffusion surface.

In addition, the upper surface of the light guiding sheet 34 may be provided with a shielding sheet 33 (having a thickness of approximately 0.075 mm) as a light shielding member which may interrupt light emitted upward from the light propagating portion 32b of the light guiding sheet 34. In the shielding sheet 33, a shielding layer (not shown) may be provided on a surface of a base sheet (not shown) so as not to permit the transmission of light. The shielding layer may be a black or dark green layer, and may be formed by printing a resin layer on the surface of the base sheet, or spattering an inorganic layer such as a metal layer.

The lower surface of the light guiding sheet 34 may be provided with a reflection sheet 35 (having a thickness of approximately 0.05 mm) as a reflection member which may reflect ht, leaking downward from the light guiding sheet 34, toward each key top 4.

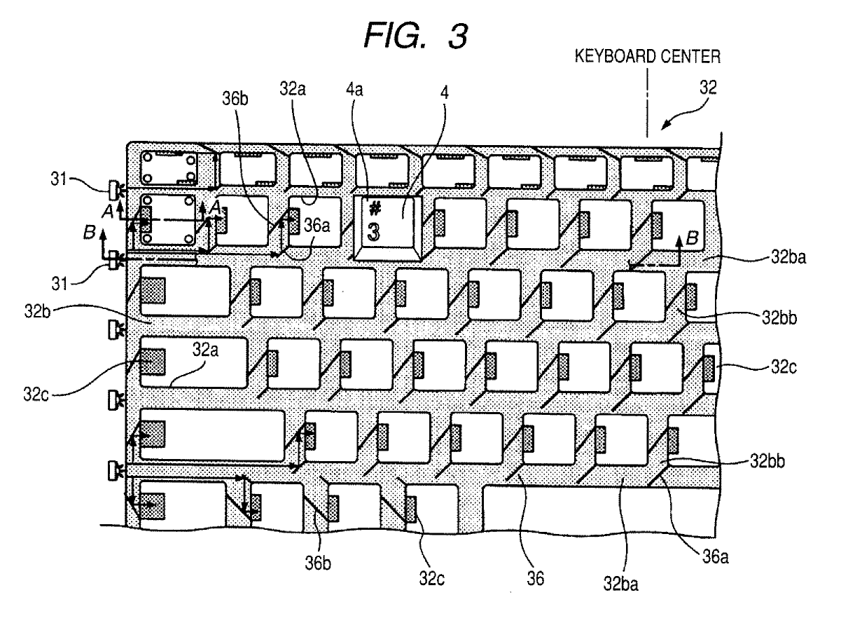

As shown in FIG. 3, the switch opening 32a may be located on the inside of the edge portion of the key top 4 so as not to protrude outward from the edge portion of the key top 4 provided it each key input unit 3, and the area of the switch opening 32a may be smaller than the area of the key top 4. As a result, the light propagating portion 32b may be always located below a gap between the adjacent key tops 4. In addition, the reflection illumination portion 32c may be disposed so as to be disposed in the vicinity of the display portion 4a provided in each key top 4.

In addition, in the keyboard device 1 of an embodiment, as shown in FIG. 3, the light guiding sheet 34 as the light guiding member body of the light guiding member 32 may be provided with a groove portion 36 as light control means which may adjust and control the light path and the light amount of light propagated to the inside of the light guiding sheet 34 so as to uniformly disperse the light in the reflection illumination portion 32c inside the light guiding sheet 34. The groove portion 36 may be formed by cutting the path of the propagated light in the light propagating portion 32b from the lower surface of the light guiding sheet 34 toward the inside.

The groove portion 36 may be formed so that a desired amount of light, having a straight advancing property and emitted from an LED 31 to a surface portion provided inside the light propagating portion 32b and formed by the groove portion 36, may be reflected and bent in a desired direction. Accordingly, the cutting angle with respect to the rear surface of the light guiding sheet 34, the cutting angle with respect to the optical axis as a control target, the cutting length in the width direction of the light propagating portion 32b, the cutting depth from the rear surface of the light guiding sheet 34, the groove width, etc. may be appropriately changed in consideration of a distance from the light source 31, so that the light path and the light amount of the light propagated to the inside of the light guiding sheet 34 may be adjusted and controlled. In this manner, it may be possible to uniformly disperse the light propagated to the inside of the light guiding sheet 34 to the reflection illumination portion 32c, and thus to concentrate the light on the reflection illumination portion 32c.

In addition, the LED 31 as the light source 31 may be fixed to a casing through an FPC 38 on the side of the light guiding sheet 34 so as to correspond to each light propagating portion 32b extending in one direction of the light guiding sheet 34. The LED 31 may have a configuration in which a bare tip of the LED 31 is accommodated in a transparent package. The LED 31 may be disposed while facing the end surface of the light guiding sheet 34 so that light emitted from the LED 31 is guided from the end surface to the inside of the light guiding sheet 34.

FIG. 3 is a plan view showing an example of the light guiding member 32 of the keyboard device 1 when seen from the upper side thereof. The surface of the light guiding member 32 may be provided with the substantially square-shaped switch openings 32a which may be opened so as to respectively correspond to the arrangement positions of the key tops 4, and the light propagating portion 32b may extend in a matrix shape in the length direction and the width direction so as to surround the switch openings 32a in four directions and to propagate the light thereinto. The light propagating portion 32b extending in the length direction may be provided with the tongue-piece-shaped reflection illumination portions 32c, each of which may extend to the inside of each of the switch openings 32a and may be interposed in a space between the key top 4 and the membrane sheet body 20.

In FIG. 3, the circle marks drawn within one switch opening 32a on the left upper side of the keyboard device indicate the positions of the engagement portion between the first support piece 5 and one end of the first movable support member 7 supporting the key top 4 and the engagement portion between the second support piece 6 and one end of the second movable support member 8 supporting the key top 4. The reflection illumination portion 32c may extend from the light propagating portion 32b to the lower side of the X-shaped support link 9 inside each switch opening 32a so as to be interposed therein.

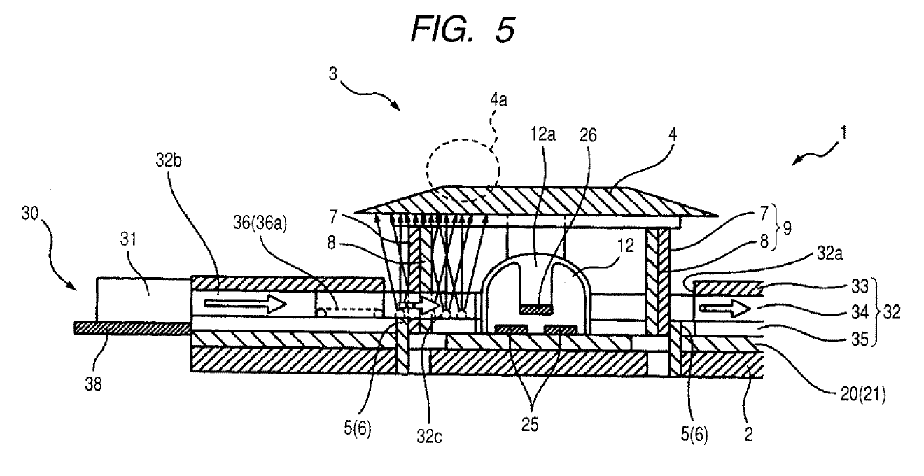

The positions of the engagement portion between the first support piece 5 and one end of the first movable support member 7 supporting each key top 4 and the engagement portion between the second support piece 6 and one end of the second movable support member 8 in each corresponding switch opening 32a may be located at four corners of the substantially square-shaped switch opening 32a as in the left upper switch opening 32a. The reflection illumination portion 32c may extend to the position inside the space between the key top 4 and the membrane sheet body 20 so as not to disturb the operation of the X-shaped support link 9, and the reflection illumination portions 32c other switch openings 32a are omitted in the drawings. In addition, the section A-A shown on the left upper side of FIG. 3 indicates a portion corresponding to the cross-sectional view of FIG. 1 (the same applied to FIG. 5).

In addition, in FIG. 3, there is only shown the key top 4 having the blank-letter-shaped display portion 4a which has images of the symbol “#” and the number “3” formed by an opening. Since the area of the key top 4 is larger than that of the switch opening 32a, the switch opening 32a in the vicinity of the key top 4 is not visible when seen from the upside thereof. In addition, the reflection illumination portion 32c may be disposed so as to be located below the display portion 4a provided in each key top 4.

In addition, the LED 31 may be disposed at one end of a first light propagating portion 32ba extending in the width direction as the longitudinal direction of the keyboard device 1 on the side of the light guiding sheet 34, so that the light emitted from the LED 31 may be guided from the end surface of the light guiding sheet 34 to the inside of the light guiding sheet 34.

In the first light propagating portion 32ba extending in the width direction, the lower surface thereof may be provided with a first groove portion 36a as light control means in accordance with the necessity. The first groove portion 36a may be used to refract the straight advancing light of the LED 31 in a second light propagating portion 32bb extending in the length direction and formed to be perpendicular to the first light propagating portion 32ba extending in the width direction. In addition, the first groove portion 36a may be formed to have an angle (the light may be reflected based on the principle of the incident angle and the reflection angle inside the light propagating portion in response to the angle of the cutting surface of the groove portion) of approximately 45° along the surface of the light guiding sheet 34 in a light bending direction with respect to the optical axis of the corresponding LED 31, and to have a depth of about ½ of the fight guiding sheet 34. The length of the groove portion 36a may be as short as the first groove portion 36a close to the light source 31, and may be as long as the first groove portion 36a provided at a position away from the light source 31. The first groove portion 36a provided at the farthest position may be formed throughout the entire width of the first light propagating portion 32ba. Likewise, when the length of the groove portion 36 is adjusted, the light of the LED 31 reaching the formation position of the groove portion 36 may be appropriately divided into the light bent to the first light propagating portion 32ba extending in the length direction and the light straight advancing in the second light propagating portion 32bb extending in the width direction.

In addition, in the second light propagating portion 32bb extending in the length direction, the lower surface thereof may be provided with a second groove portion 36b which collects light, bent by the groove portion 36 and guided to the inside of the first light propagating portion 32ba, to the reflection illumination portion 32c. The second groove portion 36b may be formed to have an angle of approximately 45° along the surface of the light guiding sheet 34 in a light bending direction with especu to the optical axis of the corresponding LED 31, and to have a depth of about ½ of the light guiding sheet 34. Regarding the length of the groove portion, the groove portion may be formed throughout the entire width of the second light propagating portion 32bb.

Then, the light emitted from the LED 31 and incident from the end surface of the light guiding sheet 34 to the light propagating portion 32b may be reflected and propagated inside the light guiding sheet 34 in accordance with the principle of the incident angle and the reflection angle. The light leaking from the light guiding sheet may be returned to the inside of the light guiding sheet 34 by the reflection of the rear surface of the shielding sheet 33 disposed on the upper surface side and the reflection of the front surface of the reflection sheet 34 disposed on the lower surface side so as to be used for the illumination. At this time, as depicted by the arrow of FIG. 3, the light propagated in the inside the light propagating portion 32b of the light guiding sheet 34 may be reflected by the first groove portion 36a and the second groove portion 36b, and may be guided to the reflection illumination portion 32c. Subsequently, the light may be emitted to the lower surface formed as the light diffusion surface as the rough surface of the reflection illumination portion 32c, may be reflected to the inside of the light guiding sheet 34, and then may be directed to the upper surface. The light leaking from the upper surface may be given to the display portion 4a of the key top 4.

Since a metallic substrate or a resinous circuit board is not disposed on the light guiding member 32, the light reflected upward from the reflection illumination portion 32c may be hig ply efficiently given to the display portion 4a, and thus the display portions 4a of all key tops 4 are clearly illuminated.

Likewise, in the keyboard device 1, the light of the LED 31 may be uniformly dispersed in the reflection illumination portion 32c inside the light guiding member body 34 regardless of the distance from the light source 31, so that the light concentrates on the reflection illumination portion 32c.

In addition, the first groove portion 36a provided in the first light propagating portion 32ba is not used only for the purpose of refracting the straight advancing light of the igat source 31 to the second light propagating portion 32bb, and the second groove portion 36b provided in the second light propagating portion 32bb is not used only for the purpose of guiding the light to the reflection illumination portion 32c. For example, if necessary, the light may be directly guided to the reflection illumination portion 32c by the groove portion 36 provided in the first light propagating portion 32ba refer to the first light propagating portion shown in the uppermost portion of FIG. 3).

Further, in the case where the light path of the light reflected by the reflection illumination portion 32c and directed to the display portion 4a is provided with the first and second movable support members 7 and 8, the first and second movable support members 7 and 8 may be formed of transparent or semi-transparent material having translucency. Also, the first and second movable support members 7 and 8 may be formed of a white synthetic material or the like so as to reflect or diffuse the light from the surface thereof, and the light reflected the reflection illumination portion 32c may be reflected or diffused by the first and second movable support members 7 and 8 so as to be given to the key top 4.

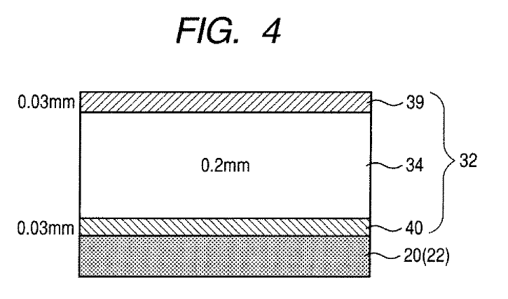

Furthermore, as shown in FIG. 4, the light guiding member 32 may have a configuration in which a light shielding layer 39 (having a thickness of 0.03 mm) as the light shielding member may be printed and provided on the upper surface of the light propagating portion 32b of the light guiding sheet 34 (having a thickness of approximately 0.2 mm), and a reflection film 40 (having a thickness of approximately 0.03 mm) as the reflection member is printed and provided on the lower surface thereof. Accordingly, it may be possible to contribute to a decrease in thickness of the keyboard device 1.

Moreover, the pressure sheet 22 may be used as the light guiding member 32. Likewise, when the pressure sheet 22 is used as the light guiding member 32, it may be possible to further contribute to a decrease in thickness of the keyboard device 1

Here, the above-described membrane switch may include the substrate sheet 21 and the pressure sheet 22 which may be laminated with the spacer layer 23 interposed therebetween, and the contact input portion 24 which may include the lower contact point 25 provided on the upper surface of the substrate sheet 21 and the upper contact point 26 disposed at a position facing the lower contact point 25 and provided on the lower surface of the flexible pressure sheet 22 covering the upper side of the lower contact point 25. When the key top 4 is pressed, the pressure sheet 22 of the contact input portion 24 may be pressed so that the upper contact point 26 may come into contact with the lower contact point 25. Here, the keyboard device may be further thinned by omitting the pressure sheet 22 and the spacer layer 23 of the membrane switch.

In detail, as shown in FIG. 5, the substrate sheet 21 of the membrane switch may be provided with two lower contact points which are spaced from each other so as to correspond to each key top 4. Each lower contact point 25 may be individually connected to a conductive pattern (not shown) wired to the substrate sheet 21. Then, the light guiding member 32 having the above-described configuration may be directly disposed on the upper surface of the substrate sheet 21. At this time, a pair of two lower contact points 25 may be located inside the switch opening 32a of the light guiding member 32. Meanwhile, the front end of the pressure convex portion 12a, facing downward and provided in the rubber dome 12 as the support member disposed on the upper surface of the substrate sheet 21 and the lower portion of the key top 4, may be provided with an upper contact point 26 which may be configured to be connected to the two lower contact points 25 so as to be in an electrical conduction state. The configurations of other constituents are the same as those of the above-described keyboard device.

In addition, in the keyboard device with such a configuration, when the key top 4 is pressed and the rubber dome 12 is pressed and crushed by the key top 4, the pressure convex portion 12a may move downward relative to the contact input portion 24, and the upper contact point 26 may come into contact with the pair of lower contact points 25 and 25, so that the two lower contact points 25 and 25 are electrically connected to each other, thereby outputting a key input signal. In the keyboard device having the membrane switch with such a configuration, since the sheet body is formed by only one sheet of the substrate sheet 21, it may be possible to realize a decrease in thickness of the keyboard device, and to reduce the material cost thereof.

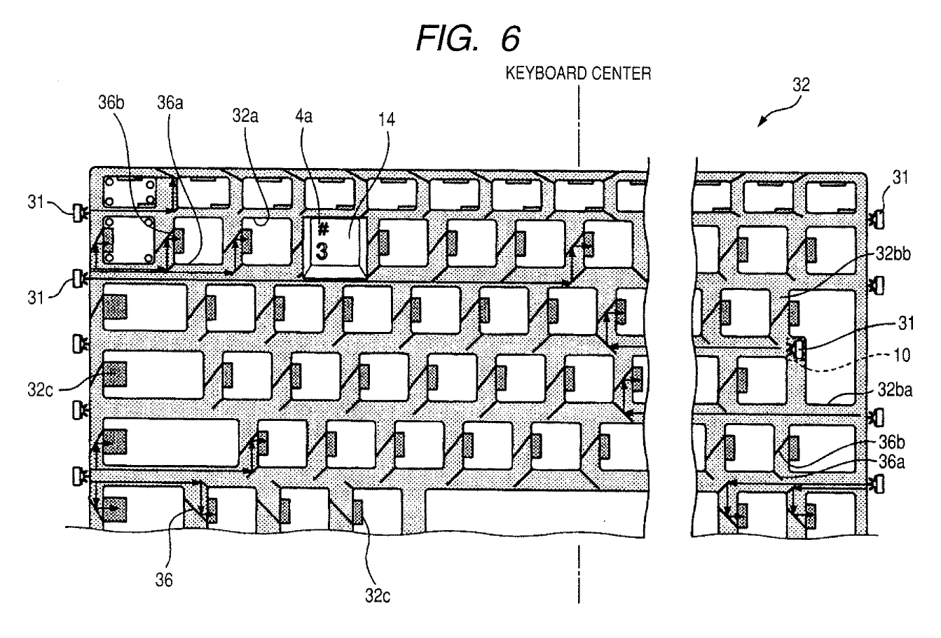

In addition, the LED 31 may be freely disposed on the side of the light propagating portion 32b of the light guiding sheet 34. For example, as shown in FIG. 6, the LEDs 31 may be disposed at both end surfaces of the light guiding sheet 34 in the width direction so as to correspond to the first light propagating portions 32ba extending in the width direction.

Even in this case, in order to uniformly disperse the light path and the light amount of the light incident from each LED 31 to the inside of the light guiding sheet to the reflection illumination portion, in the first and second groove portions 36a and 36b as the light control means provided in the light propagating portion 32b, the formation positions thereof, the cutting angle with respect to the rear surface of the light guiding sheet 34, the angle with respect to the optical axis as the control target, the cutting length in the width direction of the light propagating portion 32b, the cutting depth from the rear surface of the light guiding sheet 34, the groove width, and the like may be appropriately adjusted and controlled in consideration of the distance from the light source 31.

In addition, the LED 31 may be directly mounted by using the interconnection pattern provided on the pressure sheet 22 as the uppermost sheet of the membrane sheet body 20. As described above, the LED 31 may be disposed on the side of the light guiding sheet 34. In addition, as shown in FIG. 5, arrangement holes 10 may be appropriately provided on the rear surface of the light guiding sheet 34 so as to arrange the light sources 31 in the inside of the light propagating portion 32b, and the light sources 31 mounted to the upper surface of the membrane sheet body 20 may be arranged in the inside of the arrangement holes 10.

With such a configuration, since the interconnection substrate for supplying power of the LED 31 is omitted, it may be possible to reduce the material cost of the keyboard device. Also, since the LEDs 31 may be arranged at desired positions of the light propagating portion 32b, it may be possible to shorten a distance from each of the LEDs 31 to each of the key may be possible to efficiently use the light, and to more brightly and uniformly illuminate the key top 4.

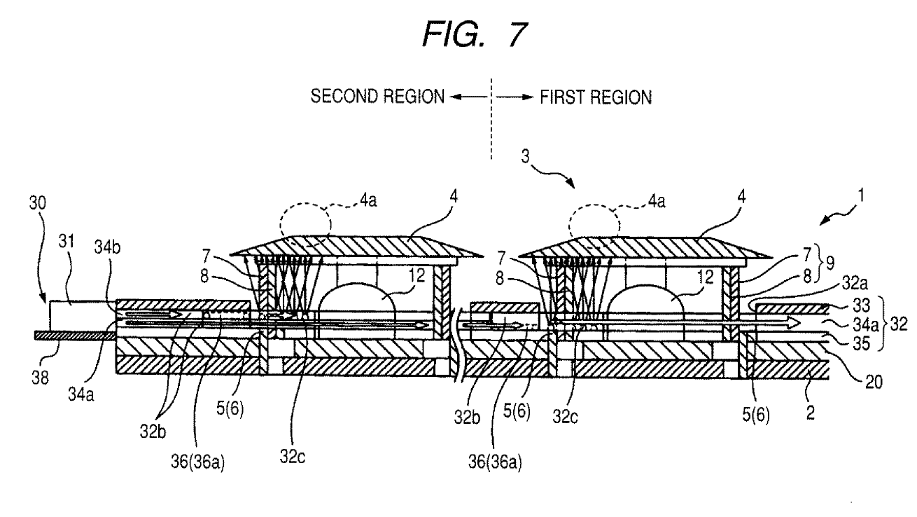

FIG. 7 is a cross-sectional view of a keyboard device having the light guiding member 32 with a configuration different from that of the above-described embodiment. In the embodiment, the light guiding member body may be partially formed as a two-layered structure. In detail, the light guiding member 32 may include a first area where one sheet of a light guiding sheet (first light guiding sheet) 34a may be disposed as the light guiding member body, and a second area where one sheet of a light guiding sheet (second light guiding sheet) 34b may be laminated on the first light guiding sheet 30a.

In the keyboard device 1, the light source 31 may be disposed on the side of two sheets of light guiding sheets 34a and 34b disposed in the second area. That is, in the keyboard device 1, for example, in the case where the light source 31 is disposed on one side of the keyboard device 1 as in the keyboard device 1 shown in FIG. 3, the second area may correspond to the area where the light source 31 is disposed, and the first area may correspond to the area on the opposite side of the light source. In addition, in FIG. 3, the part corresponding to the cross-sectional view of FIG. 7 illustrating the configuration of the light guiding member 32 of the keyboard device 1 of the embodiment is indicated by the cross-sectional line B-B.

Here, the first light guiding sheet 34a may include a first area portion provided with the light propagating portion 32b which may extends in the length and width directions within the surface of the first light guiding sheet so as to open the switch openings 32a at positions corresponding to the arrangement positions of the key tops 4 and to propagate the light to the inside of the first light guiding sheet, and the reflection illumination portion 32c which may extend from each of the light propagating portion 32b to the inside of each of the switch openings 32a so as to be interposed in a space between the key top 4 and the membrane switch 20; and a second area portion continuously and integrally formed with the first area portion of the first light guiding sheet 34a and provided with the light propagating portion 32b which may extend in the length and width directions within the surface of the first light guiding sheet so as to open the switch openings 32a at positions corresponding to the arrangement positions of the key tops 4 and to propagate the light to the inside of the first light guiding sheet.

In addition, the second light guiding sheet 34b may be provided with the light propagating portion 32b which may extend in the length and width directions within the surface of the second light guiding sheet so as to open the switch openings 32a at positions corresponding to the arrangement positions of the key tops 4 arranged in the second area so as to propagate the light to the inside of the second light guiding sheet, and the reflection illumination portion 32c which may extend from the light propagating portion 32b to the inside of each of the switch openings 32a so as to be interposed in a space between the key top 4 and the membrane switch 20.

As shown in FIG. 7, the thickness of the first area of the first light guiding sheet 34a may be designed to be equal to the thickness of two sheets of light guiding sheets 34a and 34b laminated in the second area, so that a stepped portion is provided on the surface.

Also, each of the light guiding sheets 34a and 34b may be provided with the groove portion 36 as the light control means for dispersing the light of the light source 31 to the reflection illumination portion 32c. In detail, the groove portion 36 may be provided in the second light guiding sheet of the second area so as to guide the light to the reflection illumination portion 32c disposed at a position corresponding to the key top 4 disposed in the second area. Particularly, the second area portion of the first light guiding sheet 34a is not provided with the light control means, and the light of the light source 31 may be propagated to the first area located at a position apart from the light source. In addition, in the first area, the light may be guided to the reflection illumination portion 32c, disposed at a position corresponding to the key top 4 disposed in the first area, by the groove portion 36 provided in the first area portion of the first light guiding sheet 34a.

In addition, the upper surface of the light guiding member 32 with such a configuration, that is, the upper surfaces of the light propagating portion 32b of the first area and the light propagating portion 32b of the second area are provided with a light shielding member 33 which interrupts the light emitted upward, and the lower surface of the light guiding member 32, that is, the lower surface of the first light guiding sheet 34a may be provided with a reflection member 35 which may reflect light, leaking downward from the light propagating portion 32b and the reflection illumination portion 32c, toward the key top.

According to the keyboard device with such configuration, in the second area of the light guiding member 34, the key top may be illuminated by the light propagating in the inside of the second light guiding sheet 34b, and in the first area of the light guiding member 34, the key top 4 may be illuminated by the light propagated to the second area portion of the first light guiding sheet 34a mainly disposed in the second area and arrived at the first area. When the light is propagated to the second area portion of the first light guiding sheet 34a, since most of light emitted from the light source 31 advances toward the first area due to its straight advancing property, the light may not be used as the illumination light of the second area. For this reason, it may be possible to suppress the attenuation of the light to be minimal until the light reaches the first area portion. Accordingly, the key top 4 disposed in the first area away from the light source 31 can be illuminated at sufficient brightness. In addition, since the reflection illumination portion 32c extending from the light propagating portion 32b of the light guiding sheets 34a and 34b may be interposed below the key top 4, the light emitted from the surface of the reflection illumination portion 32c of the light guiding sheets 34a and 3′b can be given to the key top 4 without much interruption, and thus the key top 4 can be highly efficiently illuminated as in the above-described embodiment.

In addition, even in the second area portion of the first light guiding sheet 34a, the light control means may be disposed so as to further uniformly guide the light toward the first area. In addition, the lower surface of the second light guiding sheet 34b of the second area may be provided with the reflection member 35 which reflects the light, leaking downward from the reflection illumination portion 32c and the light propagating portion 32b of the second light guiding sheet 34b, toward the key top, and the upper surface of the first light guiding sheet 34a of the second area may be provided with the light shielding member 33 which may interrupt the light emitted upward from the light propagating portion of the first light guiding sheet 34a. In addition, a planar light guiding sheet may be used in which the thickness of the first and second area portions of the first light guiding sheet 34a are designed to equal to each other.

Further, the above-described embodiments of the disclosure may be modified into various forms in accordance with the necessity.

For example, when the display portion 4a of the key top 4 is formed of a transparent resin material having a desired color or the rough surface of the rear surface of the reflection illumination portion 32c is tinted, light having a desired color may be emitted from the display portion 4a of each key top.

The control means is not limited to the groove portion 36 if a desired light amount of the light having a straight advancing property and emitted from the LED 31 can be reflected and bent in a desired direction. For example, instead of forming the groove portion 36 by cutting, a reflection member such as a mirror may be buried.

Although the light source is not limited to the LED, it is desirable to adopt a dot-shaped light source which emits light having a straight advancing property.

In addition, the light guiding member body is not limited to the sheet-shaped light guiding sheet, but a plate-shaped light guiding plate may be used.

Further, the groove portion provided in the first light propagating portion is not used only for the purpose of refracting the straight advancing light of the light source to the second light propagating portion, and the groove portion provided in the second light propagating portion is not used only for the purpose of guiding the light to the reflection illumination portion. For example, if necessary, the light may be directly guided to the reflection illumination portion by the groove portion provided in the first light propagating portion (refer to the first light propagating portion shown in the uppermost portion of FIG. 3).

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A keyboard device comprising:
a plurality of key tops;
a support mechanism which supports each of the key tops so as to be elevatable;
a membrane switch that outputs a switch signal when the key top moves down with an operation of the support mechanism performed upon pressing the key top; and
an illumination mechanism that includes a light source and a light guiding member, and propagates light of the light source to the inside of the light guiding member so as to illuminate the key top,
wherein the light guiding member is provided with a plurality of groove portions provided in the course of a path of the light and changing a light advancing direction, and
wherein the light reaches the key top by the groove portions.

2. The keyboard device according to claim 1,
wherein each of the groove portions is formed by cutting in the course of the path of the propagated light in a direction from the rear surface of the light guiding member to the inside thereof, and
wherein at least one of a cutting angle, a cutting length, a cutting depth, and cutting width of the groove portion is changed in response to a distance from the light source.

3. The keyboard device according to claim 1,
wherein the light of the light source is reflected and bent by the groove portions so as to be dispersed to a plurality of positions, and
wherein the light of the light source illuminates the key top by changing the light advancing direction at least one or more times.

4. A keyboard device comprising:
a base substrate;
a plurality of key tops;
a support mechanism which that is provided on the base substrate and supports each of the key tops so as to be elevatable;
a membrane switch that includes a contact input portion including lower and upper contact points disposed while facing each other in the up/down direction with a gap interposed therebetween when the key top is not pressed, and outputs a signal by allowing the corresponding lower and upper contact points of the contact input portion to come into contact with each other when the key top is pressed; and
an illumination mechanism that includes a light source and a light guiding member propagating light of the light source therein and guiding the light to each key top,
wherein the light guiding member includes:
a light guiding member body that is provided with a light propagating portion that extends in the length and width directions within the surface of the light guiding member body so as to open switch openings at positions corresponding to the arrangement positions of the key tops and to propagate the light to the inside of the light guiding member body, and reflection illumination portions, each of which extends from the light propagating portion to the inside of each of the switch openings so as to be interposed in a space between the key top and the membrane switch; and
a reflection member which that is disposed on the lower surface of the light propagating portion and the reflection illumination portions so as to reflect the light, leaking downward from the light guiding member body, toward each key top.

5. The keyboard device according to claim 4,
wherein the light guiding member is provided at the same position aas that of the membrane switch or a position closer to the key top than the membrane switch, and
wherein a light shielding member is provided on the upper surface of the light guiding member body so as to interrupt light emitted upward from the light propagating portion.

6. A keyboard device comprising:
a base substrate;
a plurality of key tops;
a support mechanism that is provided on the base substrate and supports each of the key tops so as to be elevatable;
a membrane switch that includes a contact input portion including lower and upper contact points disposed while facing each other in the up/down direction with a gap interposed therebetween when the key top is not pressed, and outputs a signal by allowing the corresponding lower and upper contact points of the contact input portion to come into contact with each other when the key top is pressed; and
an illumination mechanism that includes a light source and a light guiding member posed at the same position as that of the membrane switch or a position closer to the key top than the membrane switch and guiding the light of the light source to each key top while propagating the light therein,
wherein the light guiding member includes: a first area provided with only one sheet of a light guiding member body including a light propagating portion that extends in the length and width directions so as to open switch openings at positions corresponding to the arrangement positions of the key tops and to propagate the light to the inside of the light guiding member body, and reflection illumination portions, each of which extends from the light propagating portion to the inside of each of the switch openings so as to be interposed in a space between the key top and the membrane switch; and a second area formed as a double-layered structure in which another light guiding member body is laminated on the upper surface of the light guiding member body disposed in the first area,
wherein the light guiding member includes:
a first light guiding member body including a first area portion provided with a light propagating portion that extends in the length and width directions within the surface of the first light guiding member body so as to open switch openings at positions corresponding to the arrangement positions of the key tops in the first area and to propagate the light to the inside of the first light guiding member body, and reflection illumination portions, each of which extends from the light propagating portion to the inside of each of the switch openings so as to be interposed in a space between the key top and the membrane switch; and a second area portion continuously and integrally formed with the first area portion and provided with a light propagating portion that extends in the length and width directions within the surface of the first light guiding member body so as to open switch openings at positions corresponding to the arrangement positions the key tops in the second area and to propagate the light to the inside of the first light guiding member body,
a second light guiding member body disposed only in the second area and provided with a light propagating portion that is disposed on the upper surface of the first light guiding member body of the second area and extends in the length and width directions within the surface of the second light guiding member body so as to open switch openings at positions corresponding to the arrangement positions of the key tops in the second area portion and to propagate the light to the inside of the second light guiding member body, and reflection illumination portions, each of which extends from the light propagating portion to the inside of each of the switch openings so as to be interposed in a space between the key top and the membrane switch;
a light shielding member that disposed on the upper surface of the first light guiding member body in the first area and the upper surface of the light propagating portion of the second light guiding member body in the second area so as to interrupt light advancing toward the key top; and
a reflection member that is disposed on the lower surface of the reflection illumination portion and the light propagating portion of the first light guiding member body so as to reflect light, advancing in a direction opposite to the key top, toward each key top,
wherein at least a part of the light source is disposed on the side of the light guiding member body disposed in the second area.

7. The keyboard device according to claim 6,
wherein the light guiding member is provided at the same position as that of the membrane switch or a position closer to the key top than the membrane switch, and
wherein a light shielding member is provided on the upper surface of the light guiding member body so as to interrupt light leaking upward from the light propagating portion.

8. The keyboard device according to claim 4,
wherein the light propagating portion is provided with light control means for adjusting and controlling a light amount and a light path of the light propagated to the inside of the light guiding member body so as to uniformly disperse the light to the reflection illumination portion.

9. The keyboard device according to claim 8,
wherein the light control means is a groove portion that is provided in the course of the path of the propagated light in the light propagating portion in a direction from the rear surface of the light guiding member body to the inside thereof so as to allow straight advancing light of the light source to illuminate a surface portion provided inside the light propagating portion and to reflect and bend a desired light amount of the light to a desired direction.

10. The keyboard device according to claim 4,
wherein the lower surface of the light guiding member disposed in the reflection portion is formed as a rough surface.

11. The keyboard device according to claim 4,
wherein the key top is provided with a display portion in which an image of a desired character is formed by transmission of illumination light, and
wherein the reflection illumination portion is provided at a position corresponding to the display portion.

12. The keyboard device according to claim 4, further comprising:
a light shielding layer as the light shielding member; and
a reflection layer as the reflection member,
wherein the light shielding layer as the light shielding member is printed and provided on the upper surface of the light propagating portion of the light guiding member body, and the reflection layer as the reflection member is printed and provided on the lower surface thereof.

13. The keyboard device according to claim 4,
wherein the light source is directly mounted to an upper surface of a sheet body of an uppermost layer constituting the membrane switch.

14. The keyboard device according to claim 4,
wherein arrangement holes are provided from the rear surface of the light guiding member to the inside of the light propagating portion so as to fit and dispose light emitting portions of the light source thereinto, and
wherein at least a part of the light source is directly mounted to the inside of an area facing each of the arrangement holes in the upper surface of the sheet body of the uppermost aver constituting the membrane switch.

15. The keyboard device according to claim 4,
wherein a support member is disposed below the key top so as to support the key top, and the support member is provided with a pressure convex portion facing downward, and
wherein the membrane switch includes a contact input portion that includes a lower contact point provided on an upper surface of a substrate sheet and an upper contact point provided at a position facing the lower contact point of the pressure convex portion, and the lower contact point and the upper contact point are adapted to come into contact with each other when the key top is pressed and a pressure sheet of the contact input portion is pressed.

16. The keyboard device according to claim 1,
wherein the plurality of key tops are arranged in a pattern.

17. The keyboard device according to claim 4,
wherein the plurality of key tops are arranged in a pattern.

18. The keyboard device according to claim 4,
wherein the plurality of key tops are arranged in a pattern.

19. The keyboard device according to claim 4,
wherein the light propagating portion is provided with light control that adjusts and controls a light amount and a light path of the light propagated to the inside of the light guiding member body so as to uniformly disperse the light to the reflection illumination portion.

20. The keyboard device according to claim 19,
wherein the light control is a groove portion that is provided in the course of the path of the propagated light in the light propagating portion in a direction from the rear surface of the tight guiding member body to the inside thereof so as to allow straight advancing light of the light source to illuminate a surface portion provided inside the light propagating portion and to reflect and bend a desired light amount of the light to a desired direction.
